(19) United States
(12) Patent Application Publication
(10) Pub. No.: US 2012/0147059 A1
(43) Pub. Date: Jun. 14, 2012

(54) DISPLAY WITH DIMENSION SWITCHABLE FUNCTION

(75) Inventors: Wu-Li Chen, Changhua County (TW); Chao-Hsu Tsai, Hsinchu City (TW)

(73) Assignee: INDUSTRIAL TECHNOLOGY RESEARCH INSTITUTE, Hsinchu (TW)

(21) Appl. No.: 12/978,641

(22) Filed: Dec. 27, 2010

(30) Foreign Application Priority Data
Dec. 13, 2010 (TW) 99143524

(51) Int. Cl. G09G 3/36; G09G 5/10

(52) U.S. Cl. 345/690; 345/102

(57) ABSTRACT

A display with dimension switchable function is introduced herein. The display can selectively display 3D images or 2D images in a part of or entire of a display area of display. The display at least includes a collimated backlight module, an image display device, a light guiding module, and a switching unit. The light guiding module and the switching unit are disposed between the collimated backlight module and the image display module, and positions thereof can be exchanged according to different design requirements. The light from the collimated backlight module is directed to different viewing zones after passing through the light guiding module. By controlling diffusion states of the switching unit, the 3D images or the 2D images are selectively displayed in a part of or entire of the display area of the image display module, as required.

### CROSS-REFERENCE TO RELATED APPLICATION

This application claims the priority benefit of Taiwan application serial no. 99143524, filed on Dec. 13, 2010. The entirety of the above-mentioned patent application is hereby incorporated by reference herein and made a part of specification.

### BACKGROUND

1. Technical Field

The disclosure relates to a display with dimension switchable function, by which required three-dimensional (3D) or two-dimensional (2D) images can be selectively displayed on a part of or all of a display area of the display.

2. Related Art

In recent years, with development of technology, demands for three-dimensional (3D) displays are gradually increased. However, when a user wants to purchase a 3D display, beside requiring the 3D display to display special images, it is also one of important consideration factors whether the 3D display can be switched to a 2D display mode which can display normal images and cause less visual fatigue, and does not have a problem that small characters cannot be recognized due to resolution reduction in horizontal and vertical directions of the 3D display.

The current 3D image display techniques mainly include a glasses 3D display technique and a naked-eye 3D display technique according to whether or not a special glasses is used, and since it is inconvenient and causes extra cost to wear the special glasses to view images, the naked-eye 3D display technique is expected to have a great development in the future to become a mainstream technique. A naked-eye display may produce a 3D display effect through a parallax manner, and the 2D/3D switchable naked-eye 3D display technique can be further divided into a parallax barrier technique, a lenticular lens technique and a directional backlight technique. The parallax barrier technique is an alternative technique developed since a lenticular lens 2D/3D switchable display device is hard to be mass-produced and has high cost. However, since the parallax is generated, the parallax barrier is set to shield a part of light, so that brightness of a display thereof is inadequate, which may cause a problem of visual fatigue, and since a viewing angle thereof is the minimum in the three techniques, although it is easy to be mass-produced, practicality thereof is not high.

The directional backlight technique is mainly developed by U.S. 3M Company, though it is still under development and products thereof are not mature. Therefore, in the 2D/3D switchable naked-eye display techniques, the lenticular lens technique may provide enough brightness and a maximum viewing angle in the three techniques, and products thereof are relatively mature.

In the 2D/3D switchable naked-eye display techniques, U.S. Patent Application No. 2003/0011884 related to the lenticular lens technique discloses a solution for solving a 2D/3D switching problem of the lenticular lens technique, by which the lenticular lens of the switching device uses a diffusion layer material with an electrical switchable feature, and a transparent conductive material is coated on a front surface and a back surface of the diffusion layer material to serve as electrodes, so as to control molecule arrangement variations of the diffusion layer material to switch the 2D/3D display. The technique disclosed by the above patent has two main shortages, and one is that the 2D images are blurred due to that a certain distance has to be maintained between the lenticular lens and pixels for the 3D display effect, and when the switchable diffusion layer is switched to the diffusion state, the image pixels are blurred. Another shortage is that a profile of the lenticular lens of the switching device has multiple arcs other than planes, so that the transparent conductive electrode material is hard to be combined to the diffusion layer material, which may cause a poor yield, and mass production thereof is hard to be achieved, which may indirectly cause a high fabrication cost.

### SUMMARY

An exemplary embodiment of the disclosure provides a display with dimension switchable function. The display includes an image display device, a backlight switching module and a light guiding device. The image display device is used for displaying images. The backlight switching module selectively outputs a non-directional light or a collimated backlight or a combination thereof towards the image display device, where the collimated backlight output from the backlight switching module is emitted along a direction perpendicular to an output surface of the backlight switching module. Moreover, the light guiding device is disposed between the image display device and the backlight switching module, where when the non-directional light or the collimated backlight or the combination thereof passes through the light guiding device and is propagated to the image display device, the non-directional light or the collimated backlight or the combination thereof is propagated to the image display device in a predetermined direction, so as to display a two-dimensional (2D) image, a three-dimensional (3D) image or a 2D and 3D combination image.

An embodiment of the disclosure provides a display with dimension switchable function. The display includes an image display device, a collimated backlight source, a light guiding device, and a switching unit. The image display device is used for displaying images, and the light guiding device and the switching unit are disposed between the image display device and the collimated backlight source. Moreover, the switching unit is capable of switching a plurality of usage states, and the usage states include a first light diffusion state and a second light diffusion state, where when the switching unit switches the first light diffusion state, the collimated backlight regularly and directionally passes there through, so that the image display device displays a three-dimensional (3D) image, and in the second light diffusion state, the collimated backlight is changed to a stray and non-directional light after passing there through and is propagated to the image display device, so that the image display device displays a two-dimensional (2D) image.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a three-dimensional view of a two-dimensional (2D)/three-dimensional (3D) switchable display according to an exemplary of the disclosure.

FIG. 2(a) is a cross-sectional view of a light path of the display of FIG. 1 in case of a 2D display status according to an exemplary embodiment of the disclosure.

FIG. 2(b) is a cross-sectional view of a light path of the display of FIG. 1 in case of a 3D display status according to an exemplary embodiment of the disclosure.

FIG. 3A is a cross-sectional view of the display of FIG. 1 according to an exemplary embodiment of the disclosure.

FIG. 3B is a cross-sectional view of a variation of the embodiment of FIG. 3A where positions of a lenticular lens and a switchable diffusion layer are exchanged.

FIG. 3C is a cross-sectional view of a variation of the embodiment of FIG.

3A where a light shielding structure is added.

FIG. 4 is a three-dimensional view of a localized 2D/3D switchable display according to an exemplary of the disclosure.

FIG. 5 is a cross-sectional view of a variation of the embodiment of FIG. 3 where the material of a lenticular lens is changed to use a diffusion layer material.

FIG. 6 is a cross-sectional view of a variation of the embodiment of FIG. 3 where a fixed diffusion layer is added next to an original switchable diffusion layer.

FIG. 7(a) and FIG. 7(b) are cross-sectional views of variations of the embodiment of FIG. 3 where a diffusion layer can be moved back and forth.

FIG. 8(a) and FIG. 8(b) are cross-sectional views of variations of the embodiment of FIG. 3 where a diffusion layer is changed to a shaft stretching diffusion layer.

FIG. 9 is a cross-sectional view of a variation of the embodiment of FIG. 3 where a field angle expanding lens is added between a lenticular lens and a diffusion layer.

FIG. 10 is a cross-sectional view of a variation of the embodiment of FIG. 9 where a lenticular lens and a field angle expanding lens are combined to form a new lens.

FIG. 11 is a schematic diagram illustrating a situation that each arc surface can form one set of five different viewing zones before a field angle expanding lens is added.

FIG. 12 is a schematic diagram illustrating a situation that each arc surface can form one or more sets of five different viewing zones after a field angle expanding lens is added.

FIG. 13 is a cross-sectional view of enlarged internal details of a collimated backlight module of FIG. 3.

FIG. 14(a) is cross-sectional view of a display where movable light emitting diode (LED) grains are located on a focal plane of lens grains.

FIG. 14(b) is cross-sectional view of a display where movable LED grains are not located on a focal plane of lens grains.

FIG. 15 is a cross-sectional view of a variation of the embodiment of FIG. 14(a) and FIG. 14(b) where a backlight switching module is varied.

FIG. 16(a) is cross-sectional view of a display where movable LED grains are located on a focal plane of lens grains.

FIG. 16(b) is cross-sectional view of a display where a part of movable LED grains is located on a focal plane of lens grains, and another part thereof is not located on the focal plane of the lens grains.

FIGS. 17A and 17B are schematic diagrams illustrating patterns of collimated backlight according to an exemplary embodiment of the disclosure.

### DETAILED DESCRIPTION OF DISCLOSED EMBODIMENTS

One of exemplary embodiments of the disclosure provides a display with dimension switchable function. The display includes an image display device, a switching unit, a light guiding device and a collimated backlight source. The switching unit can switch states to display two-dimensional (2D) or three-dimensional (3D) image information or combination image information thereof. Moreover, the switching unit is disposed between the image display device and the collimated backlight source. An arranging sequence of the switching unit and the light guiding device can be exchanged. Moreover, the collimated backlight source is used for providing a collimated backlight to the light guiding device.

One of the plurality of exemplary embodiments provides a display with dimension switchable function to resolve a problem of controlling light directions, so that the 2D/3D display can be switched at any display area of the display according to user's requirement. Therefore, problems that a current 2D/3D switchable lenticular lens display is hard to be mass-produced and high cost thereof can be resolved.

Generally, in order to achieve mass production of the lenticular lens display with a highly commercialised practical technique in current naked-eyes 2D/3D switchable displays without applying a special fabrication technique, and avoid a low production yield thereof caused by high difficulty of the fabrication technique, and effectively reduce a fabrication cost thereof, the exemplary embodiments of the disclosure provide a display to achieve at least one of the aforementioned advantages. Moreover, one of or a part of the exemplary embodiments of the disclosure can also resolve a problem that the user can only view a complete 3D image within a narrow viewing range of the display due to a narrow viewing angle of the naked-eye display.

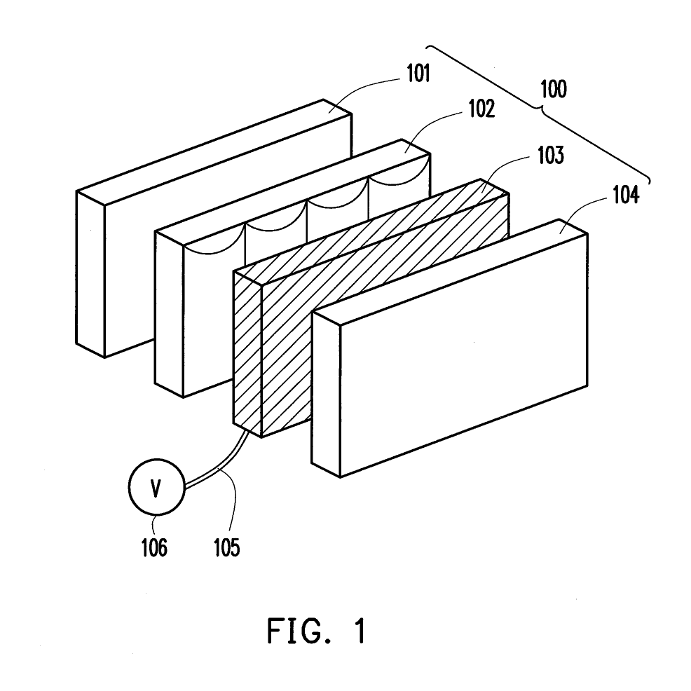

FIG. 1 is a three-dimensional view of a basic structure of a lenticular lens 2D/3D switchable display 100 according to an exemplary of the disclosure. Referring to FIG. 1, the display 100 includes a collimated backlight module 101, a lenticular lens 102, a switchable diffusion layer 103 and an image display device 104. Moreover, the display 100 further includes a wire 105 and a power supply 106.

In one of the exemplary embodiments, the display 100 has a dimension switchable function and includes a switching unit, a light guiding device and a collimated backlight source. In the present exemplary embodiment, the collimated backlight source is the collimated backlight module 101, the light guiding device is the lenticular lens 102, and the switching unit is the switchable diffusion layer 103.

The collimated backlight module 101 has a backlight source capable of providing a collimated backlight, and the collimated backlight is propagated to the lenticular lens 102 to be focused and then diverted thereof The wire 105 is used for electrically connecting the switchable diffusion layer 103 and the power supply 106. The power supply 106 controls usage states of the switchable diffusion layer 103 through the wire 105.

In one of the exemplary embodiments, a material of the switchable diffusion layer 103 can be a diffusion layer material with an electrical switchable feature, for example, a polymer dispersed liquid crystal (PDLC) material, etc., which can present an diffusive state under a first voltage (for example, a voltage of 0) and a transparent state under a second voltage. The second voltage refers to a voltage value enough for switching the state of the switchable diffusion layer 103 to a near transparent state or the transparent state. The first voltage refers to a voltage value enough for switching the state of the switchable diffusion layer 103 to the diffusive state or a near diffusive state.

When the two voltages applied, two different diffusion states are generated, though the switchable diffusion layer 103 can be operated in different diffusion states, which is not limited by the disclosure. Moreover, the switchable diffusion layer 103 may have different layout configurations, or different voltages can be applied thereon, so that different regions thereon may have different states, so as to achieve an effect that any display area can be switched to display the 2D or 3D image. For simplicity's sake, only the transparent state and the diffusive state are taken as an example for description, though the disclosure is not limited thereto. Moreover, the lenticular lens 102 can also be replaced by a diffraction grating, a lens array or other devices with the similar function, and in order to improve the 3D display effect of the display, optical structures such as a barrier with alternated transparent and opaque stripes, etc. can also be added in the structure, so as to reduce a crosstalk phenomenon of adjacent viewing zones of the 3D display.

When the switchable diffusion layer 103 is in the transparent state, it is previous to the light output from the lenticular lens 102, and can maintain and output the light with the regular direction that is output from the lenticular lens 102, which is a mode for generating a 3D image. When the switchable diffusion layer 103 is the transparent state, the switchable diffusion layer 103 scatters the light output from the lenticular lens 102, i.e. scatter the light with the regular direction that is output from the lenticular lens 102, so that the light is output in all directions, which is a mode for generating a 2D image. The image display device 104 is a display device capable of displaying 2D or 3D image information. Generally, in the display 100, the collimated backlight module 101 provides backlight source with a collimated direction, and the light is guided by the lenticular lens 102 to reach the switchable diffusion layer 103, and the power 106 controls the transparent state and the transparent sate of the switchable diffusion layer 103, so as to control the scattered and non-directional light or the regular and directional light to enter the image display device 104, and the image display device 104 correspondingly displays the 2D or the 3D image information.

In one of exemplary embodiments, a light shielding structure can be disposed between the switchable diffusion layer 103 and the image display device 104 or between the switchable diffusion layer 103 and the collimated backlight module 101, so as to reduce a crosstalk phenomenon or a deadzone phenomenon of the displayed 3D image. The light shielding structure is, for example, a barrier. The crosstalk phenomenon of the 3D image is a ratio between a luminance of the light should not be seen and a luminance of the light should be seen obtained when a specific test frame at a center of the display is measured. For example, a system crosstalk refers to a ratio between a luminance of the light should not be seen and a luminance of the light should be seen that is measured at an appointed position of the 3D image display.

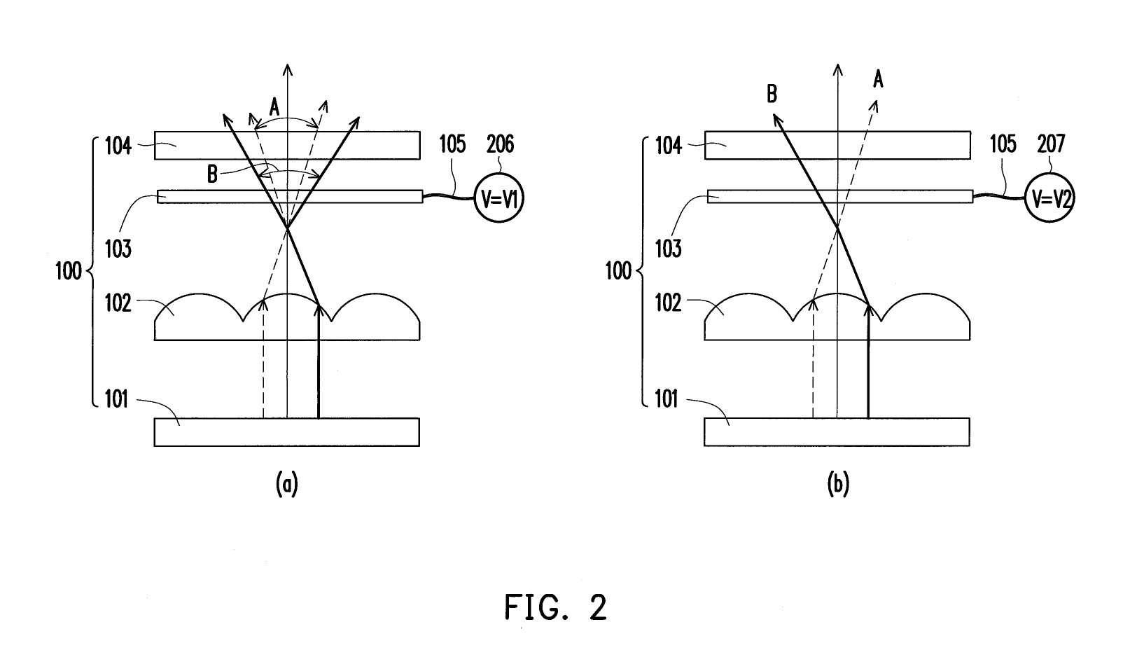

FIG. 2(a) is a schematic diagram illustrating an operation of the display 100 of FIG. 1. Referring to FIG. 2(a), a power supply 206 provides a first voltage, so that the switchable diffusion layer 103 is switched to the near diffusive state or the diffusive state. In FIG. 2(a), since the switchable diffusion layer 103 is switched to the diffusive state, after the collimated light output from the collimated backlight module 101 is guided by the lenticular lens 102, the collimated light with the regular direction is scattered to non-regular directions after passing through the switchable diffusion layer 103, and becomes a scattered light source of a certain range.

FIG. 2(b) is a schematic diagram illustrating another operation of the display 100 of FIG. 1. Referring to FIG. 2(b), a power supply 207 provides a second voltage, so that the switchable diffusion layer 103 is switched to the near transparent state or the transparent state. In FIG. 2(b), since the switchable diffusion layer 103 is switched to the transparent state, after the collimated light output from the collimated backlight module 101 passes through the switchable diffusion layer 103, it is maintained as a light source with the original regular direction.

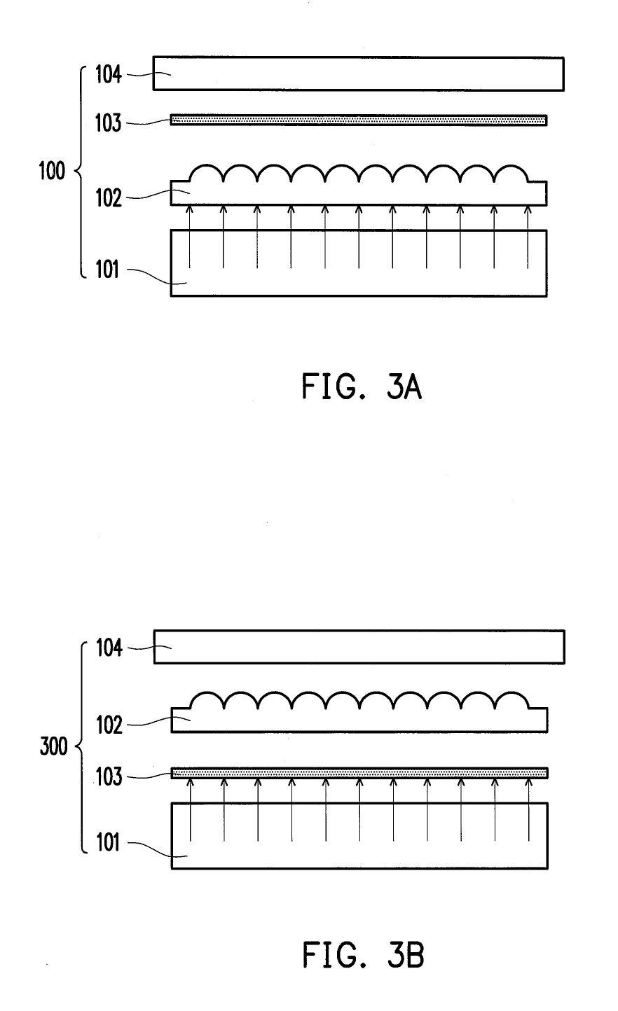

FIG. 3A is a cross-sectional view of the display 100 of FIG. 1 according to one of exemplary embodiments of the disclosure. In FIG. 3, a basic structure of the display 100 of FIG. 1 is illustrated without the wire 105 and the power supply 106, which can be used to compare structural differences with the cross-sectional views of the display 100 of a plurality of following embodiments.

FIG. 3B is a cross-sectional view of a variation of the embodiment of FIG. 3A according to an exemplary embodiment of the disclosure. Referring to FIG. 3B, arranging positions of the lenticular lens 102 and the switchable diffusion layer 103 of FIG. 3A are exchanged to obtain a display 300, so that a sequence for the light passing through the above two devices is different. After the light passes through the lenticular lens 102 and the switchable diffusion layer 103, the light entering the image display device 104 is a scattered and non-directional light or a regular and directional light, and the display device 104 correspondingly displays 2D or 3D image information. A display result and the function of switching the 2D/3D display of the image display device 104 are the same to that of the image display device 104 of FIG. 3A. Further variations of the embodiment derived based on the position exchange are also considered to be within a structural design range of the embodiment of FIG. 3.

FIG. 3C is cross-sectional view of another variation of the embodiment of FIG. 3A according to an exemplary embodiment of the disclosure. Referring to FIG. 3C, a light shielding structure 110 is selectively added between the lenticular lens 102 and the switchable diffusion layer 103. The light shielding structure 110 is used for improving a display quality of the display 100, for example, reducing the crosstalk phenomenon or the deadzone phenomenon of the displayed 3D image. The light shielding structure 110 is, for example, a barrier.

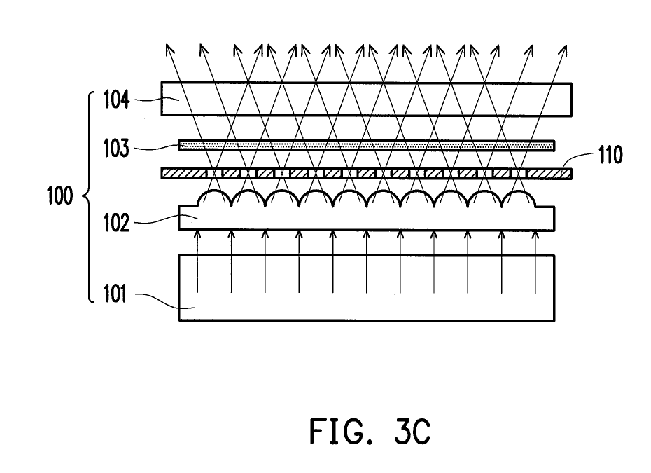

The switchable diffusion layer 103 of FIG. 3A and FIG. 3B may have minimum control area units with a size closed to a size of a pixel of the image display device 104, so that numbers, area sizes and positions of the 2D and 3D display areas can be controlled according to a switching requirement, so as to achieve the 3D display capable of displaying the 2D and 3D images in any number, any area size and any position. Referring to FIG. 4, a controller 410 can be used to control the switchable diffusion layer 103 to present the transparent state corresponding to a 3D display area 104a of the image display device 104, and present the diffusive state corresponding to a 2D display area 104b.

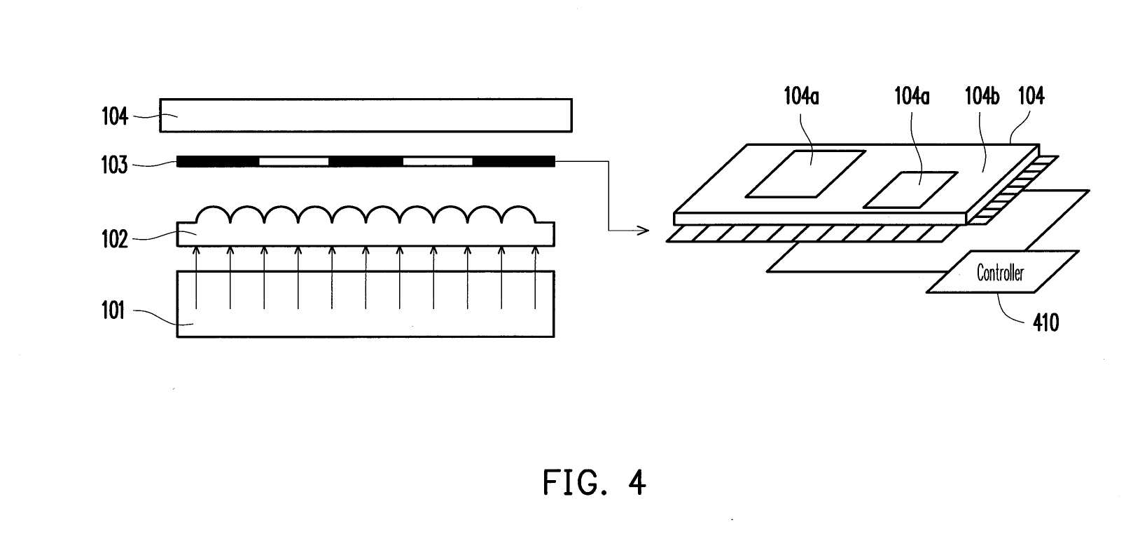

FIG. 5 is a cross-sectional view of the display of FIG. 3 with a simplified structure, in which the structure is simplified under a premise of not reducing the function and effectiveness of the embodiment of FIG. 3 as much as possible.

In the present embodiment, the display 500 has the dimension switchable function, and includes a light guiding device and a collimated backlight source. In the present exemplary embodiment, the collimated backlight source is the collimated backlight module 101, and the light guiding device and a switching unit can be implemented by a lenticular lens 502 containing a diffusion layer material to achieve functions of controlling the direction of the light and switching a light passing state.

Referring to FIG. 5, the display 500 includes the collimated backlight module 101, the lenticular lens 502 containing the diffusion layer material and the image display device 104. The lenticular lens 502 containing the diffusion layer material can provide the function of controlling the direction of the light as that does of the lenticular lens 102 of FIG. 3, and since the diffusion layer material used by the switchable diffusion layer 103 of FIG. 3 is applied, it can also provide different diffusion states, for example, the transparent state and the diffusive state under control of the voltage provided by the power supply (not shown) as that does of the switchable diffusion layer 103 of FIG. 3.

Since the switchable diffusion layer 103 is omitted in the structure of FIG. 5, the 4-layer structure of the display 100 of FIG. 3 is changed to the 3-layer structure of the display 500 of FIG. 5, by which the same output result and the function of switching the 2D/3D image or a combination thereof as that of the embodiment of FIG. 3 can be achieved. On the other hand, the display 500 with a simplified structure is achieved, and a thickness thereof is reduced.

In the exemplary embodiment, a light shielding structure can be added between the lenticular lens 502 with the diffusion layer material and the image display device 104 or between the lenticular lens 502 and the collimated backlight module 101, so as to reduce the crosstalk phenomenon or the deadzone phenomenon of the displayed 3D image. The light shielding structure is, for example, a barrier. The crosstalk phenomenon of the 3D image is a ratio between a luminance of the light should not be seen and a luminance of the light should be seen obtained when a specific test frame at a center of the display is measured. For example, a system crosstalk refers to a ratio between a luminance of the light should not be seen and a luminance of the light should be seen that is measured at an appointed position of the 3D image display.

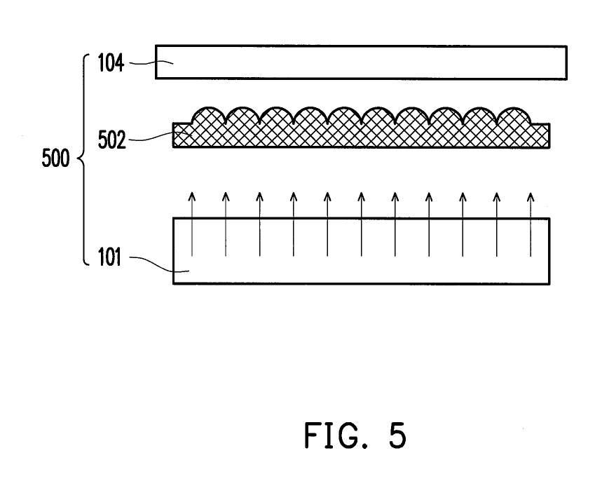

FIG. 6 is cross-sectional view of a variation of the embodiment of FIG. 3 according to one of embodiments of the disclosure. Referring to FIG. 6, a diffusion layer is further added to the display 100 of FIG. 3. The switchable diffusion layer 103 of FIG. 3 is changed to a combination of a switchable diffusion layer 603-a and a fixed diffusion layer 603-b. The switchable diffusion layer 603-a is the same to the switchable diffusion layer 103 of FIG. 3, which may have the diffusive state when the first voltage is applied, and have the transparent state when the second voltage is applied.

The fixed diffusion layer 603-b is not controlled by the voltage, and is maintained to an diffusive state.

The fixed diffusion layer 603-b is located at intersection (a focal plane) of the light after the collimated light output from the collimated backlight module 101 passes through the lenticular lens 102, which is used for expanding a viewing angle of the 3D display.

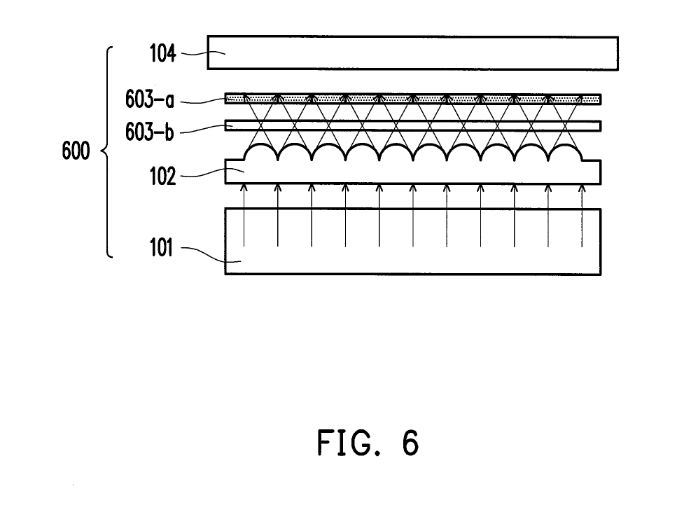

FIG. 7(a) and FIG. 7(b) are cross-sectional views of variations of the embodiment of FIG. 3 according to one of embodiments of the disclosure. Referring to FIG. 7(a) and FIG. 7(b), a fixed diffusion layer 703 is used to replace the switchable diffusion layer 103 of FIG. 3, which can be moved along a direction X. In the display 700 of FIG. 7(a), the fixed diffusion layer 703 is disposed at a non-focal plane of the light emitted from the lenticular lens 102 for displaying 2D images. In the display 700 of FIG. 7(b), the fixed diffusion layer 703 is disposed at the intersection (the focal plane) of the light emitted from the lenticular lens 102, which is used for displaying 3D images. The fixed diffusion layer 703 of the display 700 can be moved back and forth through an additional moving element 710 so as to impalement the two situations of FIG. 7(a) and FIG. 7(b) to provide the function of switching the 2D display and the 3D display. For example, in FIG. 7(a) and FIG. 7(b), the fixed diffusion layer 703 is moved up and down between a position X1 and a position X2 along a direction X perpendicular to a surface of the image display device 104, so that the light entering the image display device 104 can be the scattered and non-directional light or the regular and directional light, so as to correspondingly display 2D or 3D image information.

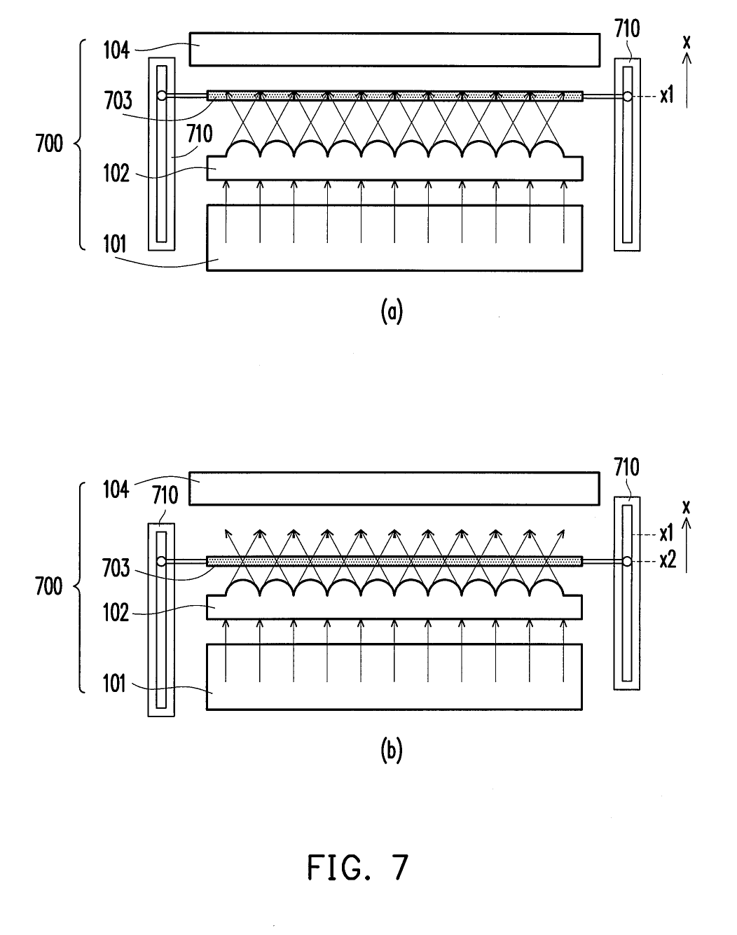

FIG. 8(a) and FIG. 8(b) are cross-sectional views of variations of the embodiment of FIG. 3 according to one of embodiments of the disclosure. Referring to FIG. 8(a) and FIG. 8(b), the switchable diffusion layer 103 of FIG. 3 is changed to a shaft stretchable diffusion layer 803, which provides a stretching function, and has two states of a shaft stretching state 803-a and a shaft contraction state 803-b. In FIG. 8(a), the display 800 is in the shaft stretching state 803-a, and a function thereof is as that of the display 100 of FIG. 3 where the switchable diffusion layer 103 is applied with a first voltage and has the diffusive state, so as to provide the 2D image display. In FIG. 8(b), the display 800 is in the shaft contraction state 803-b, and a function thereof is as that of the display 100 of FIG. 3 where the switchable diffusion layer 103 is applied with a second voltage and has the transparent state, so as to provide the 3D image display. The shaft stretchable diffusion layer 803 of the display 800 can present the shaft stretching state 803-a and the shaft contraction state 803-b through a rotation device thereon, so as to provide a stretching function of the diffusion layer to implement the two situation of FIG. 8(a) and FIG. 8(b), and provide an entire or regional display function of the 2D or 3D image display.

The switching structure of FIG. 5-FIG. 8 can also apply the control method of FIG. 4 to achieve a regional switching effect for displaying the 2D and 3D images in any number, any area size and any position.

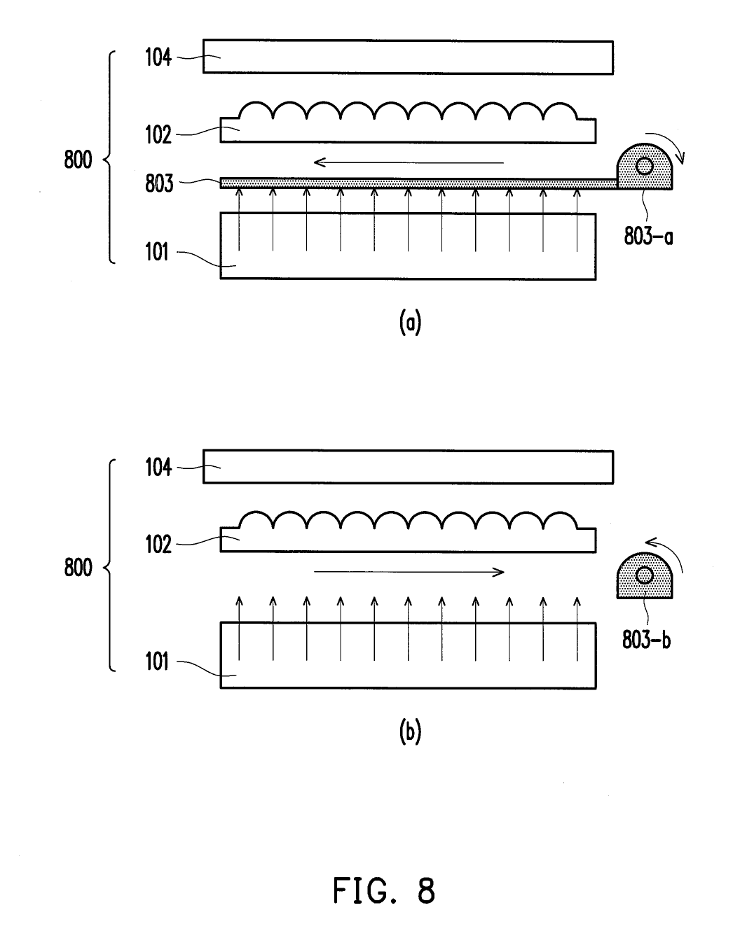

FIG. 9 is a cross-sectional view of a display according to another one of exemplary embodiments of the disclosure. Referring to FIG. 9, the display 900 of the present embodiment includes a field angle expanding lens 907 disposed between the lenticular lens 102 and the switchable diffusion layer 103, so that a range of the viewing angle of the display 900 can be increased, so as to resolve a practical problem of small viewing angle occurred when the display is used to display 3D images.

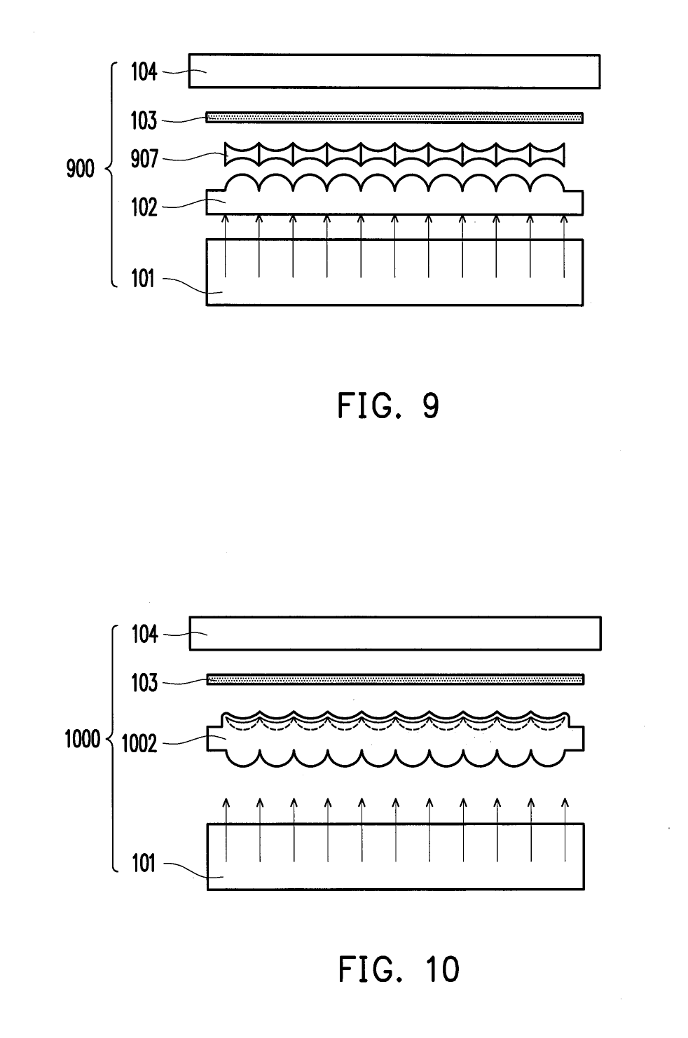

FIG. 10 is a cross-sectional view of a variation of the embodiment of FIG. 9 according to one of embodiments of the disclosure. Referring to FIG. 10, in a display 1000, the lenticular lens 102 and the field angle expanding lens 907 of the display 900 of FIG. 9 are combined into a lenticular lens and field angle expanding lens combination lens 1002, and a function thereof is as that of FIG. 9, which can expand a range of the viewing angle to resolve the practical problem of small viewing angle occurred when the display is used to display 3D images.

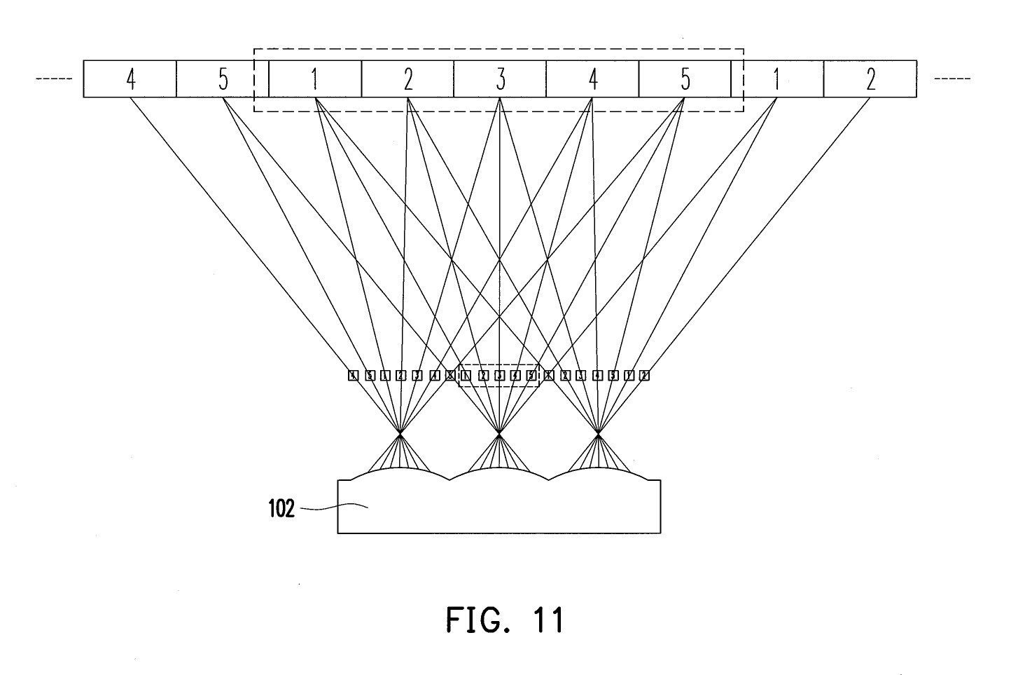

FIG. 11 is a schematic diagram illustrating a situation that the field angle overlap of the light beam can only completely cover, for example, one set of five different viewing zones corresponding to each lenslet of the lenticular lens 102 before the field angle expanding lens 907 is added, so as to form one set of five different viewing zones.

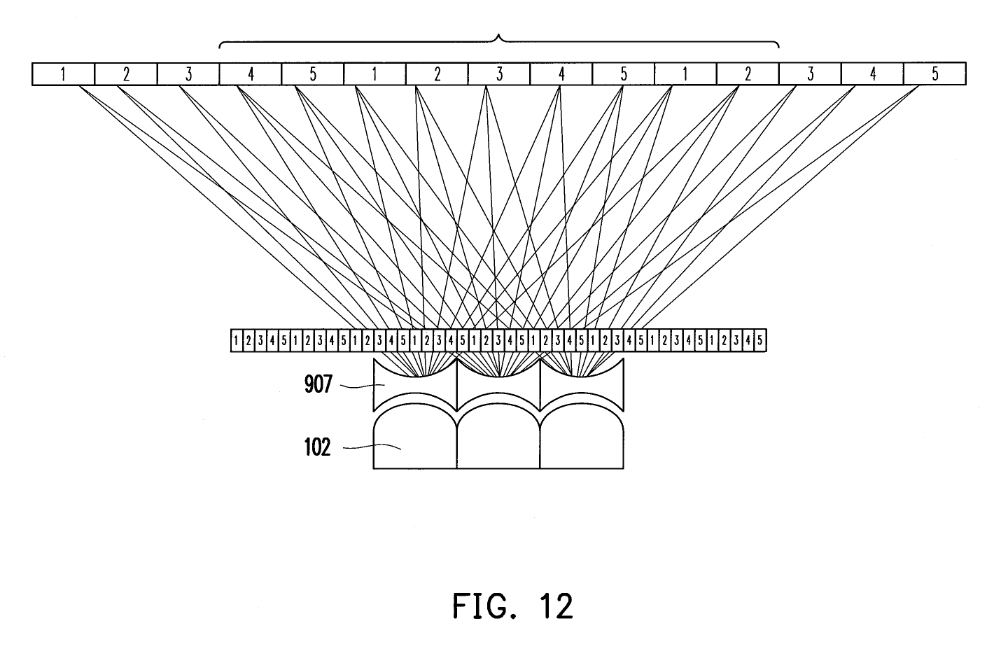

FIG. 12 is a schematic diagram illustrating a situation that the field angle overlap of the light beam can cover, for example, one or more sets of five different viewing zones corresponding to each lenslet of the lenticular lens 102 after the field angle expanding lens 907 is added, so as to form one or more sets of five different viewing zones.

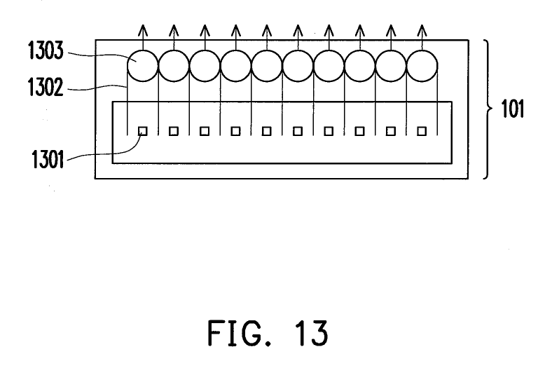

FIG. 13 is a cross-sectional view of enlarged internal details of the collimated backlight module 101 of FIG. 3. Referring to FIG. 13, the collimated backlight module 101 includes a plurality of movable light emitting diode (LED) grains 1301, a plurality of black barriers 1302 and a plurality of lens grains 1303. In the collimated backlight module 101, each of the movable LED grains 1301 is disposed on a focal plane of the lens grains 1303 under each of the lens grains 1303, so as to provide the collimated light source.

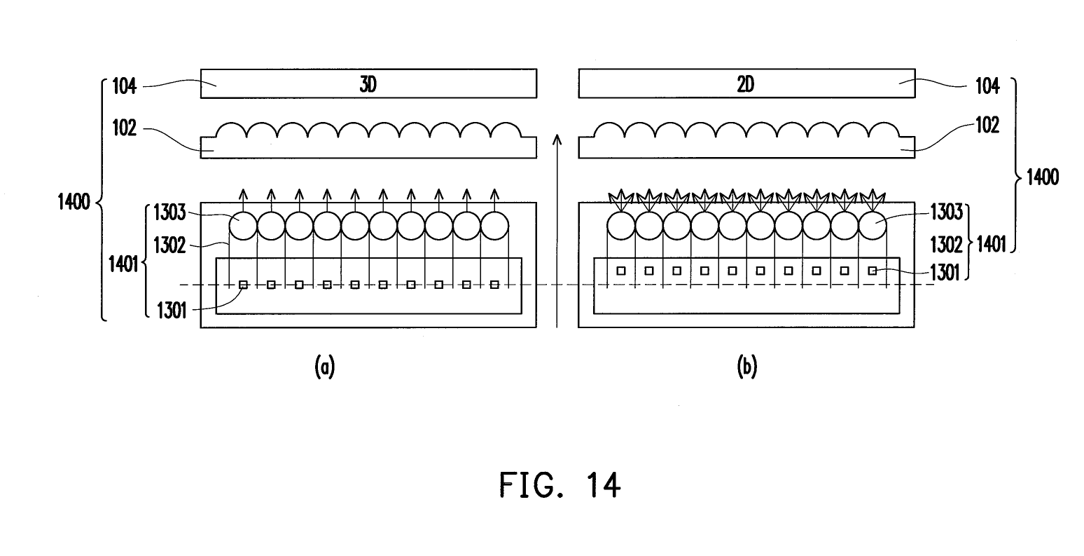

FIG. 14(a) and FIG. 14(b) are cross-sectional views of a display according to one of exemplary embodiments of the disclosure. Referring to FIG. 14(a) and FIG. 14(b), the display 1400 includes a backlight switching module 1401, the lenticular lens 102 and the image display device 104. The collimated backlight switching module 1401 of FIG. 14(a) has a plurality of the movable LED grains 1301, which are located on the focal plane of the lens grains 1303 for generating the collimated light source, so as to achieve the 3D display. The backlight switching module 1401 of FIG. 14(b) has a plurality of the movable LED grains 1301, which are not located on the focal plane of the lens grains 1303, so that a general light source is generated to achieve the 2D display. In the display 1400, the movable LED grains 1301 of the backlight switching module 1401 can be moved with assistance of an additional moving device (not shown), so as to implement the two situations shown in FIG. 14(a) and FIG. 14(b) and provide the function of switching the 2D/3D display.

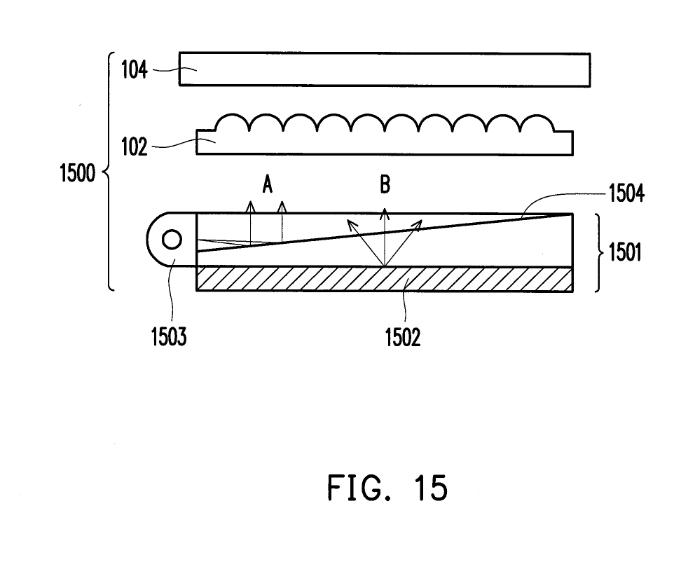

FIG. 15 is a cross-sectional view of a variation of the embodiment of FIG. 14(a) and FIG. 14(b) according to one of exemplary embodiments of the disclosure. Referring to FIG. 15, a structure of the backlight switching module 1401 of FIG. 14(a) and FIG. 14(b) is changed to form a backlight switching module 1501 of a display 1500. The backlight switching module 1501 includes a bottom light source 1502, a left light source 1503 and a transflective reflection mirror 1504. When the bottom light source 1502 is lighted and the left light source 1503 is not lighted, the bottom light source 1502 is a general light source, and the light thereof is output to the lenticular lens 102 to achieve the 2D display. When the left light source 1503 is lighted and the bottom light source 1502 is not lighted, the left light source 1503 is a collimated light source, and the light thereof is first transmitted to the transflective reflection mirror 1504 having a micro structure, and is reflected to form a collimated light, and then the collimated light is output to the lenticular lens 102 to achieve the 3D display. In the display 1500, the backlight switching module 1501 uses an additional light source switching device (not shown) to switch and turn on one of the bottom light source 1502 and the left light source 1503, so as to provide the function of switching the 2D/3D display.

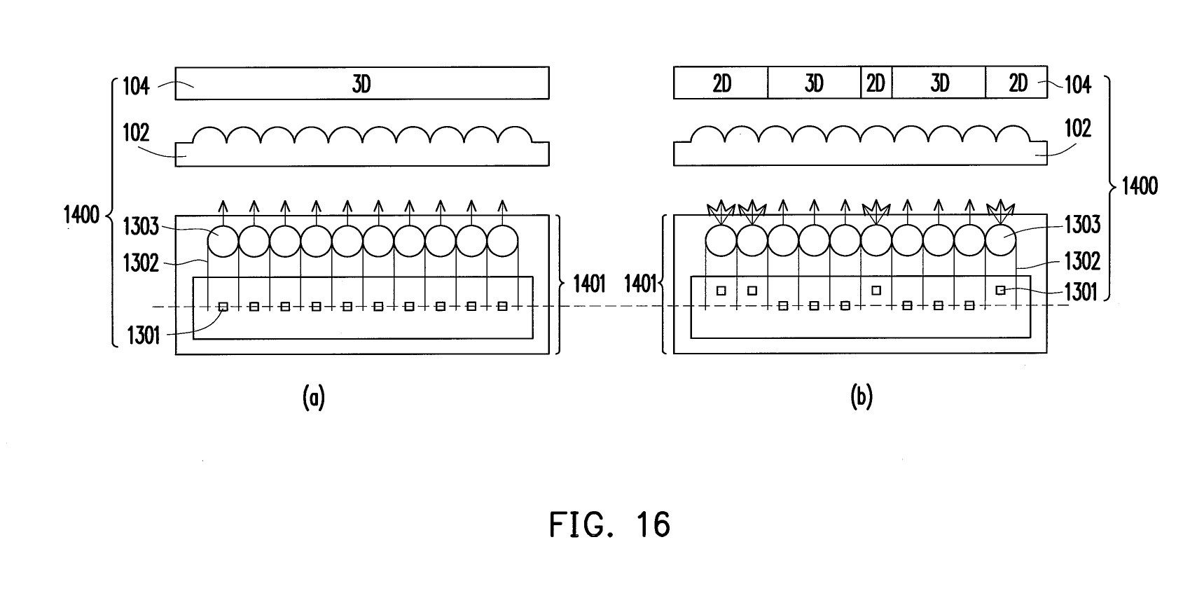

FIG. 16(a) and FIG. 16(b) are cross-sectional views of a variation of the embodiment of FIG. 14(a) and FIG. 14(b) according to one of exemplary embodiments of the disclosure. Referring to FIG. 16(a), the movable LED grains 1301 are located on the focal plane of the lens grains 1303 for generating the collimated backlight, so as to achieve the 3D display. Referring to FIG. 16(b), a part of the movable LED grains 1301 is located on the focal plane of the lens grains 1303 for generating the collimated backlight, so that this part may achieve the 3D display. The remained part of the movable LED grains 1301 is not located on the focal plane of the lens grains 1303, so that the general backlight is generated, and this part may achieve the 2D display. In the display 1400, the movable LED grains 1301 of the backlight switching module 1401 can be independently moved with assistance of an additional moving device (not shown), so as to implement the situation shown in FIG. 16(b) and provide a function of partial 2D display and partial 3D display, and a function of arbitrarily switching the 2D display or the 3D display of each position, independently.

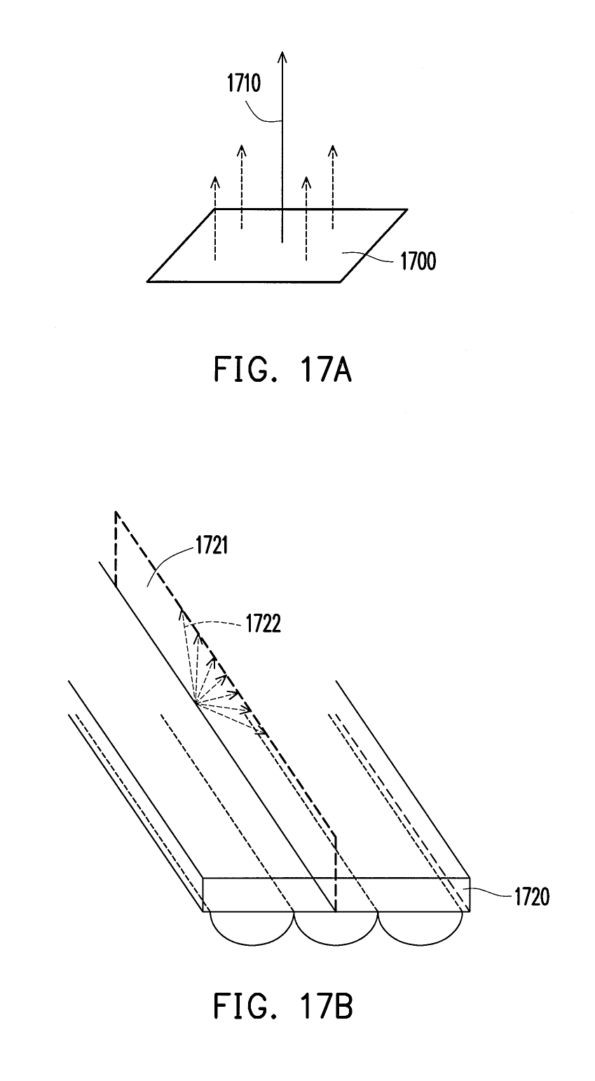

In the disclosure, the so-called “collimated backlight” has two types, and one type is that the light of the collimated backlight source is only emitted along a normal direction of the collimated backlight source, as that shown in FIG. 17A, the emitted light is propagated along a normal line 1710 of a collimated backlight source 1700. Another type is that the light of the collimated backlight source is scattered along an extending direction of an optical structure, though it is collimated along a direction perpendicular to the extending direction of the optical structure. Taking the lenticular lens as an example, referring to FIG. 17B, a light 1722 is scattered along an extending direction 1721 of an optical structure 1720. The above two types of the collimated backlight source can all be applied in the aforementioned exemplary embodiments of the disclosure to achieve the aforementioned effects.

In summary, according to some of the exemplary embodiments of the disclosure, the problem of poor production yield of the lenticular lens display caused by requiring a special fabrication method and components can be resolved, and meanwhile a mass production thereof can be achieved. In some exemplary embodiments, the problem of small viewing angle of the display can also be resolved. Moreover, in some exemplary embodiment, the general 4-layer lenticular lens display structure can be simplified to three layers, so as to reduce a thickness of the display to achieve more advantages.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A display with dimension switchable function, comprising:
an image display device, displaying images;
a backlight switching module, selectively outputting a non-directional light or a collimated backlight or a combination thereof towards the image display device, wherein the collimated backlight output from the backlight switching module is emitted along a direction perpendicular to an output surface of the backlight switching module; and
a light guiding device, disposed between the image display device and the backlight switching module, wherein when the non-directional light or the collimated backlight or the combination thereof passes through the light guiding device and is propagated to the image display device, the non-directional light or the collimated backlight or the combination thereof is propagated to the image display device in a predetermined direction guiding by the light guiding device, so as to display a two-dimensional (2D) image, a three-dimensional (3D) image or a combination of the 2D and 3D images.

2. The display with dimension switchable function as claimed in claim 1, wherein the image display device comprises at least one or a plurality of multi-dimension display areas, and the 2D image, the 3D image or the combination of the 2D and 3D images is selectively displayed on the one or the plurality of multi-dimension display areas according to a display requirement.

3. The display with dimension switchable function as claimed in claim 1, wherein the backlight switching module comprises at least two light source outputting modes, wherein one light source outputting mode is a collimated backlight mode, and another light source outputting mode is a general backlight mode, and the backlight switching module switches to output different backlight modes according to a display requirement.

4. The display with dimension switchable function as claimed in claim 1, wherein the image display device comprises an image device having a display array.

5. The display with dimension switchable function as claimed in claim 4, wherein the image display device comprises a liquid crystal panel module.

6. The display with dimension switchable function as claimed in claim 1, wherein the image display device displays a plurality of image arrangements of different viewing zones of at least one 3D image arrangement according to relative positions of the light guiding device and the image display device.

7. The display with dimension switchable function as claimed in claim 1, wherein the image display device and the backlight switching module are synchronously controlled to output a required image and a backlight source state in at least a same area, so as to switch to display the 2D image or the 3D image.

8. The display with dimension switchable function as claimed in claim 1, wherein the light guiding device has an optical device such as a diffraction grating, a lens or a lenticular lens array for distributing the non-directional light or the collimated backlight or the combination thereof along a specific direction in the space.

9. The display with dimension switchable function as claimed in claim 1, wherein a light shielding structure is added between the light guiding device and the image display device or between the light guiding device and the backlight switching module.

10. The display with dimension switchable function as claimed in claim 9, wherein the light shielding structure is a barrier with alternate transparent and opaque stripes.

11. The display with dimension switchable function as claimed in claim 1, further comprising an optical device having a diffusion function and located on a focal plane of the light guiding apparatus, for increasing a whole viewing angle of the display.

12. The display with dimension switchable function as claimed in claim 11, wherein the optical device comprises at least a diffusion layer with an electrical switchable feature, and light diffusion states of the diffusion layer are adjusted by applying different voltages.

13. The display with dimension switchable function as claimed in claim 1, further comprising a first optical device and a second optical device sequentially disposed between the image display device and the light guiding device, wherein the first optical device is a switchable diffusion layer, and the second optical device is a fixed diffusion layer, wherein the switchable diffusion layer switches different usage states when different voltages are applied, and the second optical device is located on a focal plane of the light guiding device.

14. The display with dimension switchable function as claimed in claim 1, wherein the backlight switching module is capable of being regionally controlled through a circuit and mechanism design, and the image display device synchronously outputs the 2D image, the 3D image or the combination thereof in collaboration with a plurality of backlight modes of the backlight switching module, so as to achieve a regional switching effect of displaying the 2D image, the 3D image or the combination thereof in multi-number, multi-area size and multi-position.

15. The display with dimension switchable function as claimed in claim 1, wherein the light emitted from the backlight switching module is parallel to a normal line of the backlight source or is only parallel to the normal line of the backlight source along a direction perpendicular to an extending direction of the light guiding device, and is scattered along the extending direction of the light guiding device.

16. A display with dimension switchable function, comprising:
an image display device, displaying images
a collimated backlight source, outputting a collimated backlight, wherein when the collimated backlight is output from the collimated backlight source, it is emitted along a direction perpendicular to an output surface of the collimated backlight source;
a light guiding device, disposed between the image display device and the collimated backlight source, changing a propagating direction of light; and
a switching unit, disposed between the image display device and the collimated backlight source, and capable of switching a plurality of usage states comprising a first light diffusion state and a second light diffusion state, wherein when the switching unit switches the first light diffusion state, the collimated backlight regularly and directionally passes there through, so that the image display device displays a three-dimensional (3D) image, and when the switching unit switches the second light diffusion state, the collimated backlight passing there through is changed to a scattered and non-directional light, and is propagated to the image display device, so that the image display device displays a two-dimensional (2D) image.

17. The display with dimension switchable function as claimed in claim 16, wherein the light guiding device and the switching unit are disposed between the image display device and the collimated backlight source, and positions of the light guiding device and the switching unit are suitable for being exchanged.

18. The display with dimension switchable function as claimed in claim 16, wherein the image display device displays a plurality of image arrangements of different viewing zones of at least one 3D image arrangement according to relative positions of the light guiding device, the switching unit and the image display device.

19. The display with dimension switchable function as claimed in claim 16, wherein the image display device comprises a display area, and at least one or a plurality of multi-dimension display areas is formed in the display area, and the 2D image, the 3D image or a combination of the 2D and 3D images is selectively displayed on the one or the plurality of multi-dimension display areas according to a display requirement.

20. The display with dimension switchable function as claimed in claim 16, wherein when the switching units switches different usage states in different areas, a propagating direction of the collimated backlight is adjusted in different areas, so as to selectively display the 2D image, the 3D image or the combination of the 2D and 3D images on the multi-dimension display areas of the image display device.

21. The display with dimension switchable function as claimed in claim 16, wherein the image display device comprises an image device having a display array.

22. The display with dimension switchable function as claimed in claim 21, wherein the image display device comprises a liquid crystal panel module.

23. The display with dimension switchable function as claimed in claim 16, wherein the light guiding device has an optical device such as a grating, a lens or a lenticular lens array for distributing a non-directional light or the collimated backlight or a combination thereof along a specific direction in the space.

24. The display with dimension switchable function as claimed in claim 16, further comprising an optical device having a diffusion function, wherein the optical device is located between the image display device and the light guiding device or the switching unit, and is used for increasing a whole viewing angle of the display.

25. The display with dimension switchable function as claimed in claim 16, wherein switching unit comprises at least a diffusion layer with an electrical switchable feature, and light diffusion states of the diffusion layer are adjusted by applying different voltages.

26. The display with dimension switchable function as claimed in claim 25, wherein a material of the diffusion layer comprises a polymer dispersed liquid crystal (PDLC) material.

27. The display with dimension switchable function as claimed in claim 16, wherein the switching unit comprises at least a first optical device and a second optical device sequentially disposed between the image display device and the light guiding device, wherein the first optical device is a switchable diffusion layer, and the second optical device is a fixed diffusion layer, wherein the switchable diffusion layer switches different usage states when different voltages are applied, and the second optical device is located on a focal plane of the light guiding device.

28. The display with dimension switchable function as claimed in claim 16, wherein the switching unit is capable of being regionally controlled through a circuit and mechanism design, and the image display device synchronously outputs the 2D image and the 3D image in collaboration with a diffusion state of the switching unit, so as to achieve a regional switching effect of displaying the 2D image, the 3D image or a combination of the 2D and 3D images in multi-number, multi-area size and multi-position.

29. The display with dimension switchable function as claimed in claim 16, wherein the light emitted from the collimated backlight source is parallel to a normal line of the collimated backlight source or is only parallel to the normal line of the collimated backlight source along a direction perpendicular to an extending direction of the light guiding device, and is scattered along the extending direction of the light guiding device.

30. The display with dimension switchable function as claimed in claim 16, wherein a light shielding structure is added between the light guiding device and the image display device or between the light guiding device and the collimated backlight source.

31. The display with dimension switchable function as claimed in claim 30 wherein the light shielding structure is a barrier with alternate transparent and opaque stripes.

32. The display with dimension switchable function as claimed in claim 16, wherein the switching unit is moved between the image display device and the light guiding device.

33. The display with dimension switchable function as claimed in claim 16, further comprises an actuator connected to the switching unit for adjusting a relative position of the switching device, the image display device and the light guiding device.

34. The display with dimension switchable function as claimed in claim 16, wherein the switching unit has a stretching state and a contraction state in operation, and when the switching unit is in the stretching state, the switching unit is located between the image display device and the light guiding device, and when the switching device is in the contraction state, the switching device is contracted, and is not located between the image display device and the light guiding device.

35. The display with dimension switchable function as claimed in claim 16, wherein the switching unit having the diffusion function and the light guiding device are implemented by a light guiding device having a diffusion switchable function.
